(19) United States
(12) Patent Application Publication
(10) Pub. No.: US 2011/0195386 A1
(43) Pub. Date: Aug. 11, 2011

(54) COMPUTERIZED READING LEARNING SYSTEM

(75) Inventor: Marie Carbo, Syosset, NY (US)

(73) Assignee: NATIONAL READING STYLES INSTITUTE, INC., Syosset, NY (US)

(21) Appl. No.: 12/701,100

(22) Filed: Feb. 5, 2010

(51) Int. Cl. G09B 17/00; G09B 7/00; G06F 15/16

(52) U.S. Cl. 434/178; 434/362; 434/323; 709/201

(57) ABSTRACT

A system and method for providing content to a user such as a story. The method comprises providing first content to a user from a processor and providing a first test relating to the first content to the user. A teacher may provide a second test to the user based on the first content. The method further comprises receiving a first response relating to the first test at the processor; and analyzing the first response at the processor to determine a reading level for the user. The method further comprises determining, by the processor, second content based on the reading level. The second content could be another story. The processor sends the user the second content.

### BACKGROUND OF THE INVENTION

1. Field of the Invention

This disclosure relates to a computerized reading learning system and, more particularly, to a system effective to move a student through the process of learning how to read.

2. Description of the Related Art

Techniques for teaching students how to read are well known. Many prior art techniques include providing a student with a story, asking the student to read the story, and providing questions to the student relating to the story. The questions may be used to gauge how well the student read and understood a particular story. The student's answers may be grouped together to form reports. Those reports may indicate the types of questions answered incorrectly and may provide feedback to the student regarding his or her reading skills. This disclosure relates to an improvement over these prior art systems.

### SUMMARY OF THE INVENTION

One embodiment of the invention is a method for providing content to a user. The method comprises providing first content to a user from a processor; providing a first test relating to the first content to the user; and receiving a first response from the user relating to the first test at the processor. The method further comprises analyzing the first response at the processor to determine a reading level for the user; determining, by the processor, second content based on the reading level; and providing the user with the second content.

Another embodiment of the invention is a system for providing content to a user. The system comprises a processor; a memory in communication with the processor; and a user interface. The processor is effective to provide first content to a user, provide a first test relating to the first content to the user, and receive a first response from the user relating to the first test through the user interface. The processor is further effective to analyze the first response to determine a reading level for the user; determine second content based on the reading level by searching in the memory; and provide the user with the second content from the memory.

Yet another embodiment of the invention is a computer readable storage medium having computer-executable instructions stored thereon which, when executed by a computing device, adapts the computing device to perform a method for providing content to a user. The method comprises providing first content to a user from a processor; providing a first test relating to the first content to the user; and receiving a first response from the user relating to the first test at the processor. The method further comprises analyzing the first response at the processor to determine a reading level for the user; determining, by the processor, second content based on the reading level; and providing the user with the second content.

### BRIEF DESCRIPTION OF THE DRAWINGS

The drawings constitute a part of the specification and include exemplary embodiments of the present invention and illustrate various objects and features thereof.

FIG. 1 is a system drawing of a computerized reading learning system in accordance with an embodiment of the invention.

FIG. 2 is a system drawing of a computerized reading learning system in accordance with an embodiment of the invention.

FIG. 3 is a conceptual drawing showing a database that could be used in accordance with an embodiment of the invention.

FIG. 4 is a flow chart of a process for teaching reading in accordance with an embodiment of the invention.

### DETAILED DESCRIPTION OF THE PREFERRED EMBODIMENT(S)

Various embodiments of the invention are described hereinafter with reference to the figures. Elements of like structures or function are represented with like reference numerals throughout the figures. The figures are only intended to facilitate the description of the invention or as a limitation on the scope of the invention. In addition, an aspect described in conjunction with a particular embodiment of the invention is not necessarily limited to that embodiment and can be practiced in conjunction with any other embodiments of the invention.

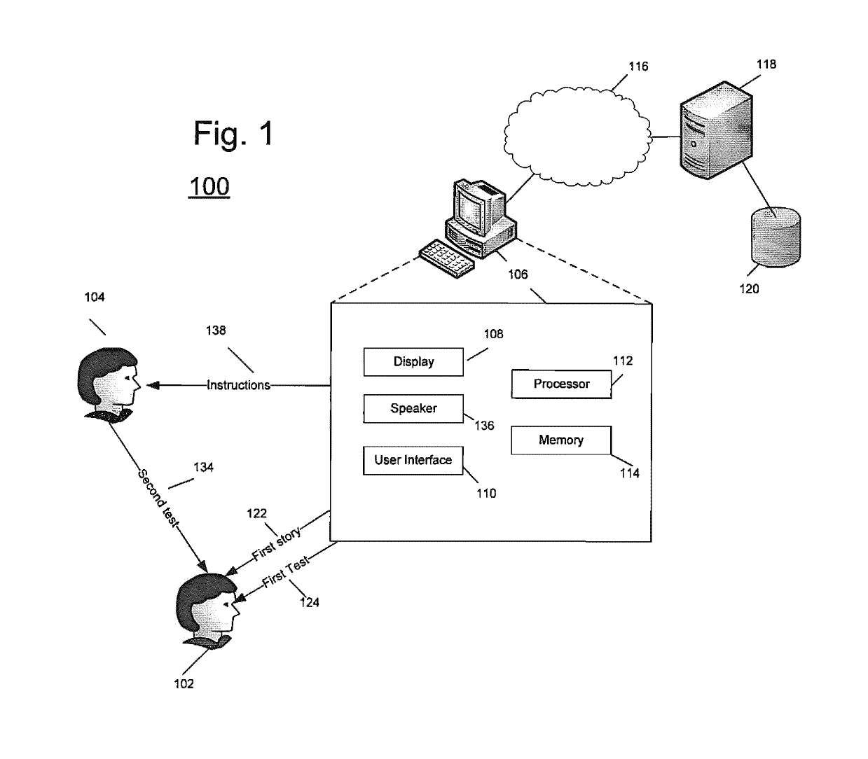

Referring to FIG. 1, there is shown a system 100 in an accordance with an embodiment of the disclosure. As discussed in more detail below, in system 100, first content, such as a story, is provided to a user. The user may read the story, and answer questions in a test based on the story. A teacher may also give the student a test based on the story. Based on the responses that the student gives to the tests, a story of perhaps a different reading level may be provided to the user.

System 100 includes a computer 106 in communication with a student 102, and a teacher 104. Computer 106 is further in communication with a network 116, such as the Internet or any other network including, for example, a local area network, a wide area network, etc. Network 116 is in communication with a server 118, and server 118 is in communication with a database 120.

Computer 106 may be, for example, a personal computer running a WINDOWS operating system, an APPLE computer running a MAC operating system, a mobile device or computer, etc. Computer 106 may include a display 108 effective to display information and/or content to user 102, and teacher 104. Computer 106 may also include a speaker 136 effective to provide audio content to user 102. A user interface 110, such as a mouse, keyboard, display on a cell phone, microphone, tablet, etc., is effective to receive information from user 102 and teacher 104. A processor 112 is effective to process instructions and is in communication with display 108, speaker 136, user interface 110 and a memory 114. Processor 112 is effective to read and process instructions stored in memory 114. Alternatively, server 118 reads and processes instructions stored in database 120. Processor 112 and server 118 may each comprise a plurality of processors and/or servers. Processor 112, or server 118 over network 116 and in conjunction with processor 112, causes display 108 to display, and/or speaker 136 to provide sound for, first content 122. For example, a browser on computer 106 may render hypertext markup language documents stored on server 118. Alternatively, computer 106 may use software other than a browser to communicate and receive information from server 118.

For example, display 108 may be controlled to display and/or speaker 136 to provide sound for, a story 122 to student 102. Other types of content may also be displayed or provided to a user such as a audio content, audio-visual content, etc. Teacher 104 may be provided with instructions 138 regarding how to test user 102 regarding first story 122. A first test 124 may, for example, be displayed on display 108, and/or provided aurally from speaker 136. First test 124 may be based on first content 122. For example, first test 124 may be a test based on a story 122, such as a set of multiple choice questions. User 102 may also be provided with a second test 134 based on first content 122. Second test 134 may be provided to user 102 by teacher 104 or may be provided aurally to student 102. Second test 134 may include, for example, teacher 104 grading factors such as words per minute read by student 102 in story 122, errors in reading words, expressions of the words, and/or a summary of story 122 provided by student 102. Teacher 104 may generate a grade for each of these factors or may send results to processor 112/server 118 which, in turn, may grade the factors. First and second tests 124, 134 may be provided to user 102 visually by display 108, aurally by speaker 136, or in a combination audio-visual format.

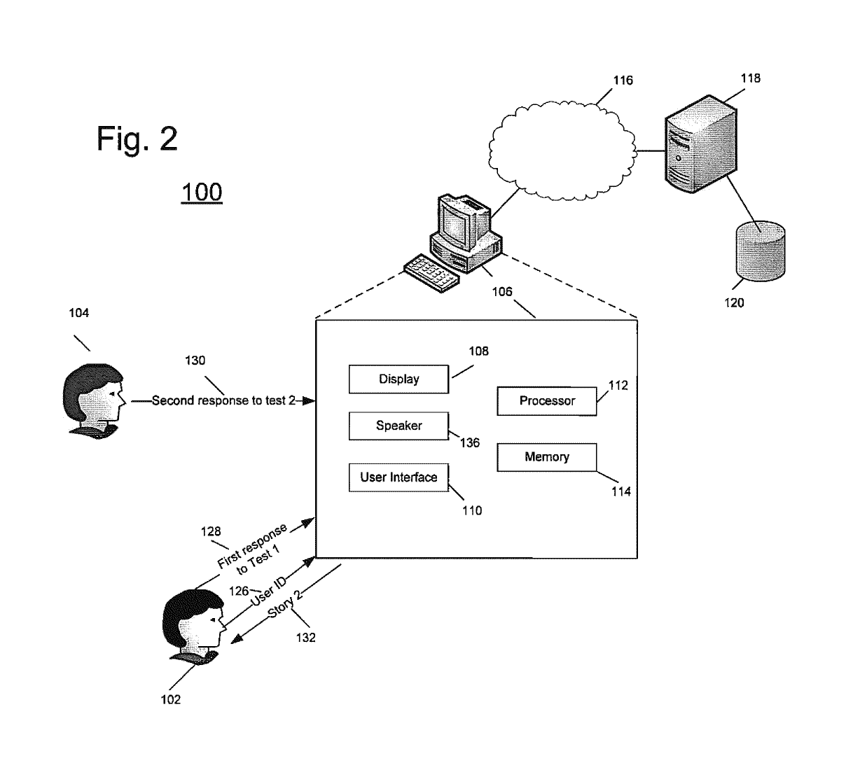

User 102 reads first story 122 and reviews first test 124 and second test 134. An introduction to first story 122 may be provided in a different language. For example, first story 122 may be in English and the introduction may be in Spanish. Referring to FIG. 2, user 102 then sends to computer 106 first response 128 and second response 130 which may be answers by student 102 to questions in tests 124, 134. User 102 may also send a user ID 126 identifying the user. First response 128 and second response 130 may both be sent through, for example, user interface 110 and then to processor 112 and/or server 118. First and second responses 128, 130 may also be sent to processor 112 and/or server 118 in other ways such as by teacher 104 postal mailing or electronic mailing responses 128, 130 to an organization running computer 106.

First and second responses 128, 130 may be analyzed by processor 112 and/or server 118. For example processor 112 and/or server 118 may compare responses 128, 130 to correct answers stored in memory 114 of database 120 to determine a number of correct answers to tests 124, 134 produced by user 102 with user ID 126. Processor 112 and/or server 118 may weigh first responses 128 and second responses 130 such as by using a table. For example, a higher weight may be assigned to first responses 128 than to second responses 130.

Based on the analyzing, processor 112 and/or server 118 determines a reading level for student 102. For example, the reading level may be calculated by using a first weight multiplied by the number of questions answered correct in test 124 plus a second weight multiplied by a score for test 134. In another example, if user 102 with a particular user ID 126 achieves a minimum grade (for example 65%) on a set number of stories at a first grade level, the user's reading level may be assigned to a second higher grade level.

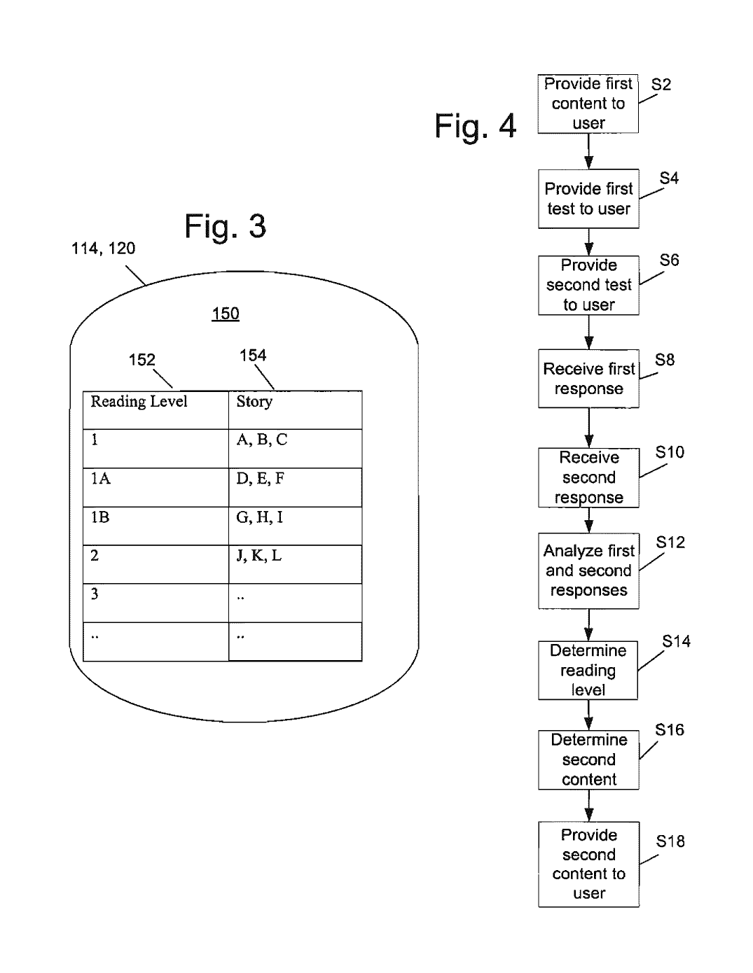

Referring now also to FIG. 4, once processor 112 or server 118 determines a reading level of user 102, processor 112 searches memory 114 or server 118 searches memory 120 to determine second content 132 to be provided to user 102. Like first content 122, second content 132 may be provided to user 102 visually by display 108, aurally by speaker 136 or in any combination. Second content 132 is based on the reading level. For example, second content 132 may come from a pool of stories relating to the determined reading level. As shown in FIG. 3, memory 114 or database 120 may each include a database 150 including a reading level 152 and stories 154. As can be seen, a pool or plurality of stories may be available for each reading level. Moreover, some stories may branch across more than one interest level. Contents of database 150 may be altered based on an age of user 102. For example, certain aged users may be able to skip a story or series of stories in a particular reading level. Such a user may be assigned a particular reading level or may be given an option to skip stories in that level.

Content 122 and 132 may indicate to user 102 a respective reading level of the stories so that user 102 may know he is working on a relatively harder or easier story level (e.g. a student in the second grade may be told that he is reading a fifth grade level story). Second content 132 may also include a prize or a set of points that could be used toward a prize such as other types of stories. For example, a wild card may be provided so that the user may be allowed to read a different set or stories or provided with more choices of stories such as comic books or chapter books. Stories of a different level than the reading level of the user may be provided. User 102 may be given the choice to read these stories purely for pleasure or take a test relating to these stories that may affect the user's reading level. In this way, user 102 can be provided with stories of higher and/or lower reading level depending upon a reading level of user 102.

When first using system 100, a student 102 may first be assessed regarding their reading level. For example, two sample stories may be provided to user 102 along with questions. As the user provides correct answers to the questions, the user may be provided with increasingly higher, more difficult level stories. When user 102 starts to get questions incorrect, teacher 104 may get involved to help assess student 102. For example, every student may start at a first grade reading level and then be assessed from that level. Each student may also be started on a low reading level story but the story may be on an interest level corresponding to the user's grade. For example, a fifth grade student may see a first story that is on a first grade reading level but at a fifth grade interest level.

Unlike prior art techniques, a system in accordance with that disclosed helps move a student through the process of learning how to read. Prior art systems simply provided reports and graphs indicating how well students were doing on tests based on stories. The disclosed system automatically and dynamically provides students with stories appropriate for their reading level. Stories may be purposefully chosen to challenge a user. Tests and content may be provided using various different screen colors and/or formats such as may be beneficial for students with visual dyslexia.

Referring to FIG. 4, there is shown a process which could be performed in accordance with the disclosure. The process of FIG. 4 could be performed using, for example, system 100 discussed above. At a step S2, a processor may provide first content to a user. The first content could be, for example, a story. At step S4, the processor may provide a first test to the user relating to the first content. At step S6, a teacher may provide a second test to the user. At step S8, the processor may receive a first response to the first test. At step S10, the processor may receive a second response to the second test.

At step S12, the processor may analyze the first and second responses. At step S14, the processor may determine a reading level of the student. For example, the reading level may be based on a number of correct answers in the first and second responses and/or a weight applied to the number of correct answers. At step S16, the processor may search a database or memory and determine second content based on the reading level of the user. At step S18, the second content may be provided to the user.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for providing content to a user, the method comprising:
providing first content to a user from a processor;
providing a first test relating to the first content to the user;
receiving a first response from the user relating to the first test at the processor;
analyzing the first response at the processor to determine a reading level for the user;
determining, by the processor, second content based on the reading level; and
providing the user with the second content.

2. The method as recited in claim 1, wherein:
the first and second content is provided to the user on a display.

3. The method as recited in claim 2, wherein the processor is in communication with the display over a network.

4. The method as recited in claim 1, further comprising:
providing a second test to the user relating to the first content;
receiving a second response relating to the second test at the processor; and
the analyzing further comprises analyzing the second response to determine the reading level.

5. The method as recited in claim 4, wherein the processor receives the second response from a second user distinct from the first user.

6. The method as recited in claim 1, wherein the reading level is determined based on a number of correct answers in the first response.

7. The method as recited in claim 1, wherein:
the first response includes a user ID; and
the reading level is determined based on a number of correct answers by the user in a plurality of first tests.

8. The method as recited in claim 1, wherein the first and second content comprise stories.

9. The method as recited in claim 1, wherein the first content is provided to the user aurally through a speaker.

10. The method as recited in claim 1, wherein the first response is received from a user interface.

11. The method as recited in claim 1, wherein the second content includes a prize.

12. A system for providing content to a user, the system comprising:
a processor;
a memory in communication with the processor; and
a user interface;
wherein the processor is effective to
provide first content to a user,
provide a first test relating to the first content to the user,
receive a first response from the user relating to the first test through the user interface;
analyze the first response to determine a reading level for the user;
determine second content based on the reading level by searching in the memory; and
provide the user with the second content from the memory.

13. The system as recited in claim 12, further comprising a display in communication with the processor and wherein the first test is provided to the user by being displayed on the display.

14. The system as recited in claim 12, wherein the processor is in communication with the display over a network.

15. The system as recited in claim 12, further comprising a speaker in communication with the processor and wherein the first test is provided to the user aurally from the speaker.

16. The system as recited in claim 12, wherein:
the processor is further effective to receive a second response relating to a second test; and
the processor is effective to determine the reading level based on the first and second responses.

17. The system as recited in claim 12, wherein the reading level is determined based on a number of correct answers in the first response.

18. The system as recited in claim 12, wherein:
the first response includes a user ID; and
the reading level is determined based on a number of correct answers by the user in a plurality of first tests.

19. The system as recited in claim 12, wherein the first and second content comprise stories.

20. A computer readable storage medium having computer-executable instructions stored thereon which, when executed by a computing device, adapts the computing device to perform a method for providing content to a user, the method comprising:
providing first content to a user from a processor;
providing a first test relating to the first content to the user;
receiving a first response from the user relating to the first test at the processor;
analyzing the first response at the processor to determine a reading level for the user;
determining, by the processor, second content based on the reading level; and
providing the user with the second content.
